(19) United States
(12) Patent Application Publication
(10) Pub. No.: US 2026/0073442 A1
(43) Pub. Date: Mar. 12, 2026

(54) Using Trained Machine-Learning Model to Generate User Interface Prompting User of an Online System to Use Different Conversion Channel

(71) Applicant: Maplebear Inc., San Francisco, CA (US)

(72) Inventors: Brent Scheibelhut, Toronto (CA); Mark Oberemk, Toronto (CA); Charles Wesley, San Diego, CA (US); Naval Shah, Toronto (CA); David McIntosh, San Francisco, CA (US); Benjamin Chevoor, Toronto (CA)

(21) Appl. No.: 18/830,444

(22) Filed: Sep. 10, 2024

(51) Int. Cl. G06Q 30/0601

(52) U.S. Cl. CPC G06Q 30/0641; G06Q 30/0625

(57) ABSTRACT

An online system uses a trained machine-learning model to create an online cart or a physical cart for a user of the online system. Upon receiving a signal with an indication about an interaction by the user with one or more items via a first conversion channel of the online system, the online system retrieves one or more candidate items for the user to convert via a second conversion channel of the online system that is different from the first conversion channel. The online system applies the machine-learning model to output a conversion score for each retrieved candidate item that indicates a likelihood of conversion. Responsive to the conversion score being above a threshold score, the online system generates a user interface at a device associated with the user prompting the user to use the second conversion channel for conversion of each retrieved candidate item.

### BACKGROUND

Online shopping has become popular. In online shopping, a user places an order with an online system, which then dispatches a fulfillment agent to pick up the order at a source location and delivers the order to the user. The omnichannel online shopping refers to the ability to add items to an order and complete the order both online and in a source location (i.e., using different conversion channels of the online system). For example, a user of the online system can add items to an online cart from a source location or add items online for pickup in a source location. However, user behavior and activity have pronounced differences depending on the channel used for online shopping. For example, users shop differently depending on whether they are in a source location versus online. Users also shop differently per source (e.g., retailer) and shop differently at different times of day or week.

Hence, there is a technical problem of how to predict, for a given user as well as at a large scale for a collection of users of an online system, a likelihood that a user will add items to an online cart from a source location and a likelihood that a user will add items online for pickup in a source location.

### SUMMARY

Embodiments of the present disclosure are directed to using a trained machine-learning model of an online system to create an online cart (e.g., for a user of the online system who is in a source location) and a physical cart (e.g., for a user of the online system who is currently online and building an online order). The trained machine-learning model facilitates generating a user interface of the online system prompting the user to use a conversion channel of the online system that is different from a conversion channel of the online system currently utilized by the user.

In accordance with one or more aspects of the disclosure, the online system receives, via a network from a device associated with a user of the online system, a signal indicating an interaction by the user with one or more items via a first conversion channel of the online system. Responsive to receiving the signal, the online system retrieves, from a database of the online system or the device associated with the user, one or more candidate items for the user to convert via a second conversion channel of the online system that is different from the first conversion channel. The online system accesses a candidate item evaluation machine-learning model of the online system, wherein the candidate item evaluation machine-learning model is trained, based on conversion data, to identify a likelihood of conversion of each of the one or more candidate items by the user when using the second conversion channel. The online system applies the candidate item evaluation machine-learning model to output, based at least in part on information about the user and information about the candidate item, a conversion score for each of the one or more candidate items that indicates the likelihood of conversion. Responsive to the conversion score being above a threshold score, the online system generates a user interface signal for prompting the user to use the second conversion channel for conversion of each of the one or more candidate items. The online system generates, based on the interface signal, a user interface at the device associated with the user prompting the user to use the second conversion channel for conversion of each of the one or more candidate items.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example smart shopping cart associated with an online system, in accordance with one or more embodiments.

FIG. 4 illustrates an example architectural flow diagram of using a trained machine-learning model of an online system to create an online cart for a user of the online system in a source location and a physical cart for a user of the online system who is currently online, in accordance with one or more embodiments.

FIG. 5 is a flowchart for a method of using a trained machine-learning model of an online system to create an online cart for a user of the online system in a source location and a physical cart for a user of the online system who is currently online, in accordance with one or more embodiments.

### DETAILED DESCRIPTION

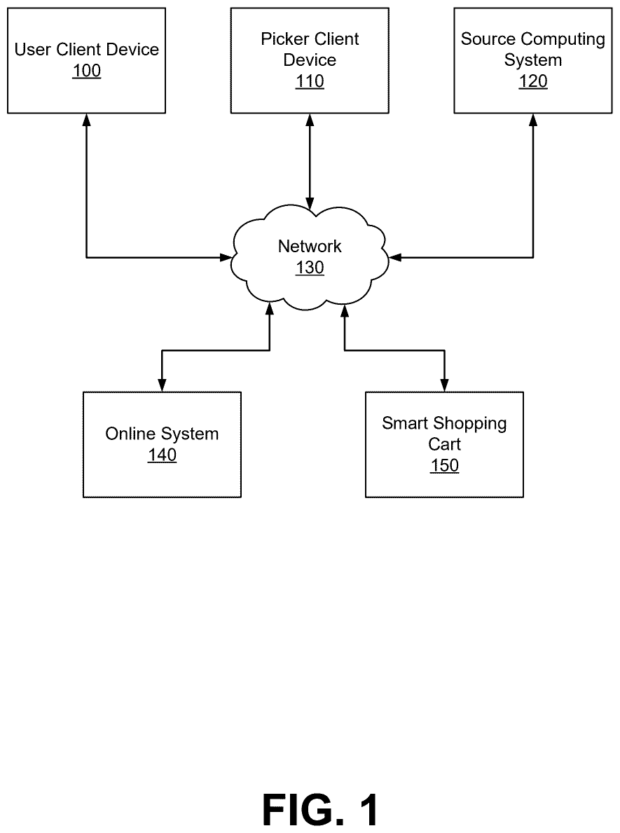

FIG. 1 illustrates an example system environment for an online system 140, in accordance with one or more embodiments. The system environment illustrated in FIG. 1 includes a user client device 100, a picker client device 110, a source computing system 120, a network 130, an online system 140, and a smart shopping cart 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with the smart shopping cart 150 being used by a user to collect items in a source location. For example, the smart shopping cart 150 may display content received from the online system 140 and may receive data describing items that are collected by the user and stored in a storage area of the shopping cart. In some embodiments, the smart shopping cart 150 is a picker client device 110 being operated by a picker collecting items within a source location. Similarly, the smart shopping cart 150 may be operated by a user within the source location collecting items for themselves. Example embodiments of smart shopping carts 150 are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 enables users to add items to an order and convert items both online and in a source location, i.e., using different conversion channels of the online system 140. The online system 140 may apply an algorithm to determine when to recommend to a user of the online system 140 who is currently in a source location to add items to an online cart or to a user of the online system 140 who is currently online to add items to a physical cart in the source location. The algorithm may relate an item or item category to an event, such as when a user checks out in a source location without buying an item that is on the user's conversion list. When the algorithm is triggered by the event, the online system 140 may add a corresponding item to a candidate list. The online system 140 may evaluate each candidate from the candidate list using a trained machine-learning model that scores each candidate, e.g., based on a likelihood of conversion if a recommendation is made. The online system 140 may then send a message to a user client device 100 recommending adding one or more of the candidate items to an online cart or to a physical cart in a source location based on events that happened in the other conversion channel.

The online system 140 presented herein thus recommends a user to opt for fulfillment of an order through a different conversion channel, e.g., “add to online cart” from a source location, or “add to in-store cart” from an online interface the online system 140. For example, a user of the online system 140 may in a source location and using the smart shopping cart 150, and the online system 140 may deduce (e.g., based on an amount of time the user with the smart shopping cart 150 spent in a particular aisle and/or visual data of the source location, as gathered by sensors of the smart shopping cart 150) that the user wishes to purchase a heavy or bulky item (e.g., a case of sparkling water) that the user purchases frequently in the source location (e.g., established based on user's order history). In such cases, the online system 140 may cause a user interface of the smart shopping cart 150 to automatically prompt the user with the following notification: “Hey-we know you like this sparkling water. Want to add it to your online cart so you don't have to carry it home? We can deliver it!” In addition to prompting the user to add the heavy or bulky item to their online cart, the online system 140 may recommend to the user, in the same notification or as an upgrade option, consumer packaged goods (CPG) promoted item variety (e.g., bottled water variety). This feature drives the stickiness of the online system 140 since the user would be then prompted to make an online order in the future via a user interface of the online system 140.

The same principle can be applied vice versa when a user of the online system 140 is online and the online system 140 wants to highlight certain qualities of items, or a source location is eager about getting users of the online system 140 into the source location to see certain items. For example, a source associated with the online system 140 can be passionate about getting users in a source location to see some of their house-made items. In such cases, the online system 140 may prompt the users by sending, via user interfaces of the user client devices 100, a notification to “Add to your instore list” certain item. Additionally or alternatively, when the user creates an order online, and the online system 140 may prompt the user to utilize a different conversion channel such that the online order would be converted as a pickup order, i.e., the user would be prompted to come to a source location to pick up the order, and, optionally, finalize the checkout process in the source location.

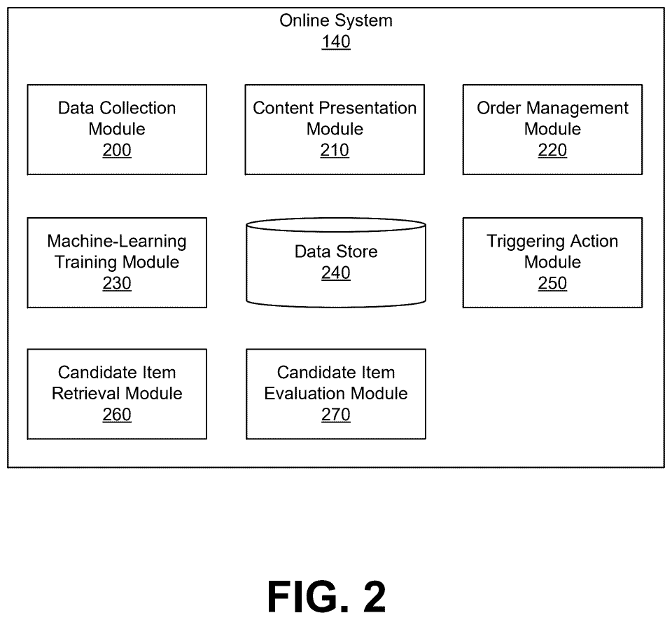

User behavior and activity have pronounced differences depending on a conversion channel of omni-channels of the online system 140 used for conversion of items. For example, users shop differently depending on whether they are in a source location versus online. Users also shop differently per source (e.g., retailer) and shop differently at different times of day or week. The online system 140 presented herein optimizes different conversion channels to support these differences in user behavior and conversion activity. The online system 140 presented herein enables users to add items to their online carts while in a source location or to their physical carts when online (or to their pickup carts for user that would only pick up a checked-out order to bring items home) via notifications triggered based on a confluence of factors and differences in omnichannel conversion. Additionally, the online system 140 may leverage these notifications to “Add to Online Cart” vs. “Add to Instore Cart” as CPG ad placement opportunities. The online system 140 is described in further detail below with regards to FIG. 2.

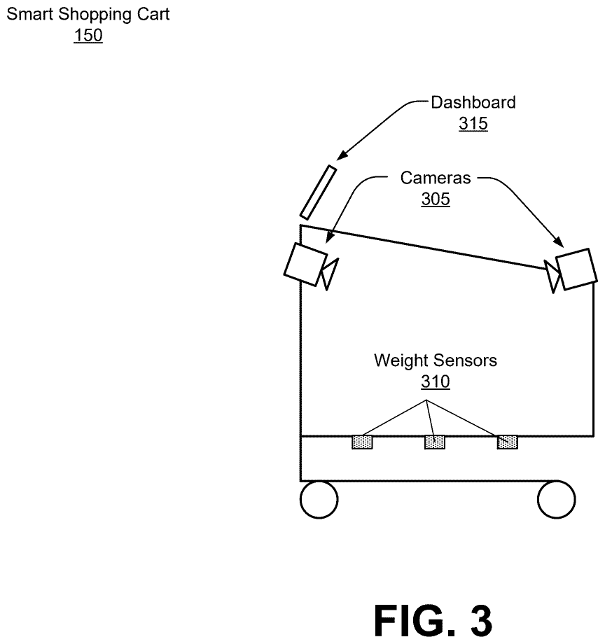

The smart shopping cart 150 is an in-store shopping cart that enables a user of the online system 140 to physically add (i.e., place) items from a source location (e.g., retail store) into the smart shopping cart 150 and check the items out from the source location without an involvement of an employee of the source at the point of sale. The smart shopping cart 150 may be connected to the online system 140 via the network 130. During the shopping session, the smart shopping cart 150 may utilize various sensors (e.g., one or more weight sensors, one or more cameras, etc.) to gather visual data about the source location and user's shopping activity, including, but not limited to, a location of the smart shopping cart 150 in the source location, weight changes of the smart shopping cart 150 as items are added to or removed from the smart shopping cart 150, video of the user's activity in and around the smart shopping cart 150, images of items added to the smart shopping cart 150, video and/or images of shelfs in the source location, video and/or images of an entrance/exit of the source location, some other visual inputs from the source location, or some combination thereof. In one or more embodiments, the smart shopping cart 150 is considered being a part of the online system 140. It should be noted that the concepts described herein in relation to the smart shopping cart 150 can be extended and/or applied to other form factors, such as a handheld shopping basket, a handheld receptacle, or some other handheld object that can be used to receive and store shopping items. The smart shopping cart 150 is described in further detail below with regards to FIG. 3.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a triggering action module 250, a candidate item retrieval module 260, and a candidate item evaluation module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The triggering action module 250 may trigger a flow at the online system 140 that would ultimately determine whether to recommend to a user of the online system 140 who is currently in a source location to add specific items to an online cart or to a user of the online system 140 who is currently online to add specific items to a physical cart in a source location. In one or more embodiments, the triggering action module 250 triggers the flow based on an algorithm (e.g., set of rules) that specifies an item that is to be considered as a candidate item when a certain action occurs. In such cases, the algorithm may specify that an item X becomes a candidate item when an event Y happens. Alternatively or additionally, the algorithm may specify an item category, and the triggering action module 250 may determine a specific item from the item category for a user of the online system 140 based on the user's preferences (e.g., item of a preferred brand). In one or more other embodiments, the triggering action module 250 triggers the flow by prompting a language model (e.g., large language model (LLM)) to identify the candidate item, e.g., based on known user preferences included in a prompt input into the LLM.

The triggering action module 250 may determine when to trigger the flow, i.e., when to apply the algorithm (e.g., set of rules) or when to prompt the LLM to identify a candidate item. Alternatively, the triggering action module 250 may trigger the flow when the user is ready to check out, either online or in a source location. Alternatively, the triggering action module 250 may trigger the flow just after the user's checkout, either the online checkout or the checkout in a source location. For example, the triggering action module 250 may trigger the flow when an item was on a user's conversion list, but the user did not check out with the item. Or, the triggering action module 250 may trigger the flow when an item is identified (e.g., by the aforementioned algorithm or the LLM) that would complete/complement a recipe with other items that the user purchased.

The triggering action module 250 may trigger the flow when there is information that a user of the online system 140 is near a specific item (e.g., bulky or heavy item) in a source location, as determined by sensors (e.g., cameras) of the smart shopping cart 150 and/or sensors (e.g., security cameras) in the source location. Alternatively, the triggering action module 250 may trigger the flow based on a weight of the smart shopping cart 150, e.g., when sensors of the smart shopping cart 150 determine that the smart shopping cart 150 is getting heavy (e.g., above a threshold weight). Alternatively, the triggering action module 250 may trigger the flow based on a time spent in a certain section of the source location (e.g., in an aisle with bulky/heavy items), as determined by sensors (e.g., cameras) of the smart shopping cart 150 and/or sensors (e.g., security cameras) in the source location.

FIG. 3 illustrates an example smart shopping cart 150 associated with the online system 140, in accordance with one or more embodiments. The smart shopping cart 150 may have one or more cameras 305 that collect video data and/or image data in relation to shelfs (i.e., store aisles) with various stored items as a user that utilizes the smart shopping cart 150 for in-store shopping is passing by. The one or more cameras 305 may further collect video data and/or image data in relation to various parts of the source location. The one or more cameras 305 may further collect video data and/or image data in relation to items placed in the smart shopping cart 150, such as a weight of each item as indicated in an item label, a brand of each item, a name of each item, a price of each item, etc. Additionally, the one or more cameras 305 may collect video data and/or image data in relation to actions in and around the smart shopping cart 150, such as a location of the smart shopping cart 150 in a source location (e.g., store) when a certain action occurs (e.g., when an item is added to the cart), user's gestures when placing items in the smart shopping cart 150, video and/or images of user's interactions with the smart shopping cart 150, track the location of the user in the source location, measure a velocity of the smart shopping cart 150 in the store, etc. Alternatively or additionally, the smart shopping cart 150 may be equipped with one or more weight sensors 310 that measure a weight of each item placed in the smart shopping cart 150, as well as a total weight of the smart shopping cart 150 with items placed to a receptacle of the smart shopping cart 150.

The smart shopping cart 150 may further include a dashboard 315 that operates as a user interface that displays a list of items added to a receptacle of the smart shopping cart 150 and can be used for the checkout. The dashboard 315 may be further used for providing notifications to the user that utilizes the smart shopping cart 150 for in-store shopping. The smart shopping cart 150 may include additional sensors not shown in FIG. 3. The dashboard 315 or some other component of the smart shopping cart 150 may further include a computing system that is in communication, via the network 130, with the user client device 100, the picker client device 110, the source computing system 120, and/or the online system 140. Data gathered by various sensors of the smart shopping cart 150 may be uploaded via the network 130 at the online system 140 (e.g., via the triggering action module 250) to be used as input features for triggering the flow at the online system 140.

In one or more embodiments, the triggering action module 250 prompts a user of the online system 140 to create an online cart (when the user is in a source location) or a physical cart (when the user is online) at different stages of the user's interaction with the online system 140 (i.e., user's session). Different notifications and different candidate items can be considered for different stages of the user's session. The content presentation module 210 (or some other module of the online system 140) may prompt the user at the beginning of their session because the algorithm predicts the user will buy water during the current session and the online system 140 wants to leverage an extra space saved by having the bottles of water delivered to a user's home location for a pricier upsell on the bottom tray of their cart. Alternatively, the content presentation module 210 may prompt the user to use a delivery option for some fresh produce right at the start of the user's session in a source location given that users tend to explore that section first.

Alternatively, the content presentation module 210 may prompt the user as the user is pushing the smart shopping cart 150 to the parking lot, e.g., when the user is finishing their session in the source location. For example, if the user forgot to buy water (as identified by the sensors of the smart shopping cart 150), the content presentation module 210 may prompt the user with the following notification at the dashboard 315 of the smart shopping cart 150: “Tap this button to get the water delivered to your home.” Alternatively, upon the online system 140 notices after the checkout that the user had been building a recipe, the content presentation module 210 may prompt the user with the following notification at a user interface of the user client device 100 or the dashboard 315 of the smart shopping cart 150: “Hey we noticed you're making Sugar Cookies and the new hot addition is Tonka Beans. Want to get them delivered?”

In one or more embodiments, the weight of the smart shopping cart 150 triggers a user's notification. If the online system 140 notices that the smart shopping cart 150 is slowing down or getting heavy (e.g., based on velocity measurements or weight measurements by sensors of the smart shopping cart 150), the content presentation module 210 may prompt the user to get one of the heavier items delivered or the future items on their source location conversion list not yet added to the smart shopping cart 150 get delivered. For example, for a user with a source location conversion list at the user client device 100, if the online system 140 determines that the smart shopping cart 150 is filling up but they only have around 60% of their list checked off, the online system 140 may project that remaining items would not fit in the smart shopping cart 150 anymore. This information may be then used by the content presentation module 210 to generate a notification for the dashboard 315 of the smart shopping cart 150 with an offer for the user to deliver the remaining items to a home location of the user.

The candidate item retrieval module 260 may identify and retrieve one or more candidate items for recommendation to a user of the online system 140. In one or more embodiments, the candidate item retrieval module 260 identifies a candidate item that was previously purchased by the user (e.g., Buy It Again item). In one or more other embodiments, the candidate item retrieval module 260 identifies a candidate item that complements a recipe. In one or more other embodiments, the candidate item retrieval module 260 identifies a candidate item as an item from a user's source location conversion list that remained unconverted. In one or more other embodiments, the candidate item retrieval module 260 identifies a candidate item as a sponsored item (e.g., sponsored by a source associated with the online system 140). A third-party sponsor may indicate the triggering action for the item to be recommended (i.e., to become a candidate item). For example, the triggering action may be that if the user adds an item X to the smart shopping cart 150, then the candidate item retrieval module 260 may identify an item Y as a candidate item for home delivery. In one or more other embodiments, the candidate item retrieval module 260 identifies a candidate item from a list of items that are on the user's in-store shopping list as an item that matches requirements set by the online system for big and bulky items.

The candidate item evaluation module 270 may access a candidate item evaluation model (e.g., machine-learning model) that is trained to evaluate a candidate item (e.g., identified by the candidate item retrieval module 260) and determine whether to recommend the candidate item to a user of the online system 140. The candidate item evaluation module 270 may deploy the candidate item evaluation model to run a machine-learning algorithm to output, based on a set of inputs, a conversion score for the candidate item that indicates a likelihood of conversion of the candidate item by the user. The conversion score may be a value between 0 and 1, where a higher value of the conversion score indicates a higher likelihood of the user's conversion of the candidate item, and a lower value of the conversion score indicates a lower likelihood of the user's conversion of the candidate item. A set of parameters for the candidate item evaluation model may be stored at one or more non-transitory computer-readable media of the candidate item evaluation module 270. Alternatively, the set of parameters for the candidate item evaluation model may be stored at one or more non-transitory computer-readable media of the data store 240.

In providing the set of inputs to the candidate item evaluation model, the candidate item evaluation module 270 may provide user data, information about the candidate item, contextual features, some other data for evaluating the likelihood of user's conversion of the candidate item, or some combination thereof. In providing the user data to the candidate item evaluation model, the candidate item evaluation module 270 may provide data with information on whether the user that utilizes the smart shopping cart 150 for shopping in the source location is spending a certain time period (e.g., longer than a threshold time period) in an aisle with an abundance of bulky items (e.g., water cases, furniture, power tools, etc.). This data may be gathered by the cameras 305 of the smart shopping cart 150 and/or by security cameras in the source location, and communicated from the smart shopping cart 150 and/or the source computing system 120 to the candidate item evaluation module 270 of the online system 140 via the network 130.

In providing the user data to the candidate item evaluation model, the candidate item evaluation module 270 may further provide past user online data. One of the goals of the online system 140 presented herein is to build the online ordering habit with users who do not already have it. Thus, if the user has ordered a case of sparkling water in online orders three times already, there is no need for the online system 140 to further prompt the user to order this particular item online, as the user would likely order this item online later. On the other hand, the online system 140 is more likely to prompt the user in cases where the user is not already a regular online orderer, or where the user has ordered a particular item regularly in in-store orders but not in online orders. Hence, the past user online data provided to the candidate item evaluation model may include information about items that were regularly ordered online and information about other items that were regularly ordered in in-store orders. The candidate item evaluation module 270 may retrieve the past user online data from the data store 240.

In one or more embodiments, based on the past user online data, the candidate item evaluation model may output a conversion score for a candidate item that is above a threshold conversion score. The online system 140 may then prompt the user, via the content presentation module 210, to add the candidate item to the user's online cart without knowing exactly what the user wants. In such cases, the content presentation module 210 may generate a notification for displaying at the dashboard 315 of the smart shopping cart 150, such as “Searching for a heavy item? Want to add it to your online cart” and letting the user scan the barcode and auto-add to an online cart via a user interface of the user client device 100.

In providing the information about the candidate item to the candidate item evaluation model, the candidate item evaluation module 270 may provide data with information about an availability of the candidate item in the source location, e.g., information on whether the candidate item is out-of-stock in the source location. The information about the candidate item may be provided to the online system 140 from the smart shopping cart 150 and/or the source computing system 120 via the network 130. In one or more embodiments, when the user is in a source location (e.g., using the smart shopping cart 150 or a source location conversion list stored at the user client device 100) and cannot find a set of items in the source location, the content presentation module 210 prompts the user, based on outputs of the candidate item evaluation model for the set of items as candidate items, to add these items to an online order where these items would come from the same source but from a different source location that does have the items in stock.

In one or more other embodiments, the information about the candidate item includes inventory data for the source location with information that certain items that are out-of-stock in the source location will be replenished within a certain time period (e.g., few hours). Note that the identified out-of-stock items do not include a complete list of out-of-stock items in the source location but only those items that the user frequently purchases, which is information available from the past user online data. In such cases, the content presentation module 210 may prompt the user, based on a conversion score for each candidate item output by the candidate item evaluation model, to add these out-of-stock items to an online order. For example, the content presentation module 210 may generate a notification for displaying at the dashboard 315 of the smart shopping cart 150, such as “Do you want these items delivered in four hours,” which is followed by a list of out-of-stock items that are frequently converted (online or in the source location) by the user.

In one or more embodiments, the online system 140 starts running the flow (e.g., via the triggering action module 250) of retrieving a candidate item by the candidate item retrieval module 260 followed by evaluating the candidate item by the candidate item evaluation module 270 and the candidate item evaluation model at different stages of user's shopping session (e.g., online shopping session or in-store shopping session). The triggering action module 250 may start running the flow when the user starts the shopping session. Alternatively or additionally, the triggering action module 250 may start running the flow during an idle time (e.g., when no item is added to the smart shopping cart 150 after a threshold amount of time expires). Alternatively or additionally, the triggering action module 250 may start running the flow when the user spends more than a threshold amount of time in specific aisles in the source location (e.g., isles with big and bulky items). Alternatively or additionally, the triggering action module 250 may start running the flow when the user adds items to their cart (either the smart shopping cart 150 or the online cart). Alternatively or additionally, the triggering action module 250 may start running the flow when the user finishes the checkout and leaves the source location, e.g., without purchasing certain big and bulky items that are on the user's in-store list.

The machine-learning training module 230 may perform initial training of the candidate item evaluation model using training data. The machine-learning training module 230 may generate the training data by collecting information about past item recommendations provided to a collection of users of the online system 140 including information about conversion of recommended items by the collection of users. Alternatively or additionally, the machine-learning training module 230 may generate the training data by retrieving information from a user order history (e.g., stored at the data store 240) if the user missed a key item that the user usually purchases. Alternatively or additionally, the machine-learning training module 230 may generate the training data by collecting information (e.g., from the data store 240) about items that have a sufficiently high conversion rate for a specific shopping channel. For example, if most users tend to order bulky water items online, the candidate item evaluation model would be initially trained to prompt users with an option to add a bulky water item to their online list. Alternatively or additionally, the machine-learning training module 230 may generate the training data by collecting user data (e.g., from the data store 240) about their orders in source locations, pickup orders, and delivery orders, such as information that a collection of users of the online system 140 prefer purchasing meat and produce in the source location, big and bulk cleaning supplies or heavy home supplies as online delivery, and prepared foods as pickup. The machine-learning training module 230 may train the candidate item evaluation model using the training data to generate initial values for the set of parameters of the candidate item evaluation model.

The machine-learning training module 230 may collect feedback data with information about whether the user accepted (i.e., converted) the prompted items. Alternatively or additionally, the content presentation module 210 may generate a question for displaying at a user interface of the user client device on whether the prompt with suggested item(s) for online delivery (or in-store shopping) was useful. The user's response may be recorded at the user client device 100 and provided as a part of the feedback data to the machine-learning training module 230. The machine-learning training module 230 may then re-train the candidate item evaluation model by updating the set of parameters of the candidate item evaluation model using the feedback data.

Based on an output of the candidate item evaluation model, e.g., a conversion score for a candidate item being above a threshold score, the content presentation module 210 may generate and send, via the network 130, a prompt for displaying at a user interface of a device associated with a user (e.g., the dashboard 315 of the smart shopping cart 150 or the user client device 100). In one or more embodiments, the content presentation module 210 generates the prompt for displaying at a user interface of the user client device 100 suggesting that the user comes in the source location to pick up an item or a set of items. In one or more other embodiments, the content presentation module 210 generates the prompt for displaying at a user interface of the user client device 100 or the dashboard 315 of the smart shopping cart 150 when the user is in the source location suggesting a home delivery for an item or a set of items.

In one or more embodiments, based on outputs of the candidate item evaluation model, the content presentation module 210 sends prompts to a user of the online system 140 different time intervals during the user's interaction with the online system 140 (i.e., online session or session in a source location). During the user's session in the source location, the content presentation module 210 may generate a prompt for displaying at a user interface of the user client device 100 or at the dashboard 315 of the smart shopping cart 150, such as “Hey-we know you like this sparkling water. Want to add it to your online cart so you don't have to carry it home? We can deliver it! Add it to your online cart!” Depending on the context and a conversion channel of the online system 140, the prompt would not just apply to adding items to the user's online cart, but also to the user's source location conversion list or to a pickup order at a separate source location.

In one or more embodiments, the online system 140 that integrates the candidate item evaluation model (i.e., “smart prompt system”) can be leveraged apart from the user's current interaction with the online system 140. For example, a certain time period (e.g., a few days) after the user's session is over, the content presentation module 210 may prompt the user if they wanted to convert more of an item in bulk, where the item was converted during the user's last session. Alternatively, based on an output of the candidate item evaluation model, the content presentation module 210 may prompt a user of the online system 140 after the user inspected/approved an item in person before deciding to purchase the same item online on a much larger scale. For example, the online system 140 may gather information from the user's purchase history (e.g., retrieved from the data store 240) that the user recently purchased one item of a specific brand (e.g., bottle of a particular brand of tonic) that the user has never purchased before. In such cases, the content presentation module 210 may prompt the user after a certain time period (e.g., few days later) if they wanted to purchase online the same item on a larger scale (e.g., six-pack of the same brand of tonic). Alternatively, when a user of the online system 140 is building online a large order for delivery, based on an output of the candidate item evaluation model, the content presentation module 210 may prompt the user to try out one or more items from the online order (e.g., food items) in a source location.

In one or more embodiments, a third party associated with the online system 140 (e.g., brand owner) can bid on triggering the flow (e.g., via the triggering action module 250) of retrieving a candidate item followed by evaluating the candidate item by the candidate item evaluation model at one or more stages of user's interaction with the online system 140 (e.g., online session or session in a source location). For example, the third party can bid on triggering the flow when, e.g., when event X happens (e.g., conversion of a particular item), then suggest conversion of an item Y (e.g., item of particular brand) that is sponsored by the third party.

Hence, the smart prompt system presented herein represents a potential for consumer-packaged goods (CPG) entities to promote their products (items). An item promoted by a CPG entity may be ranked higher in a list of items that are promoted to users of the online system 140 as a brand-new suggested item or as the “choice” of a specific product (e.g., bottled water) offered for delivery. Alternatively, sources themselves can be entities that bid on triggering the flow, such as a source that wants users of the online system 140 (i.e., online users currently in online sessions) to come in a source location to view/try specific items, such as items of a brand that is owned by the source. Additionally or alternatively, upselling from an item of a smaller size (e.g., can) that is purchased in a source location to the same item of a larger scale (e.g., case) that is delivered to a user's location may count as an advertising slot by the online system 140 that facilitates the upselling.

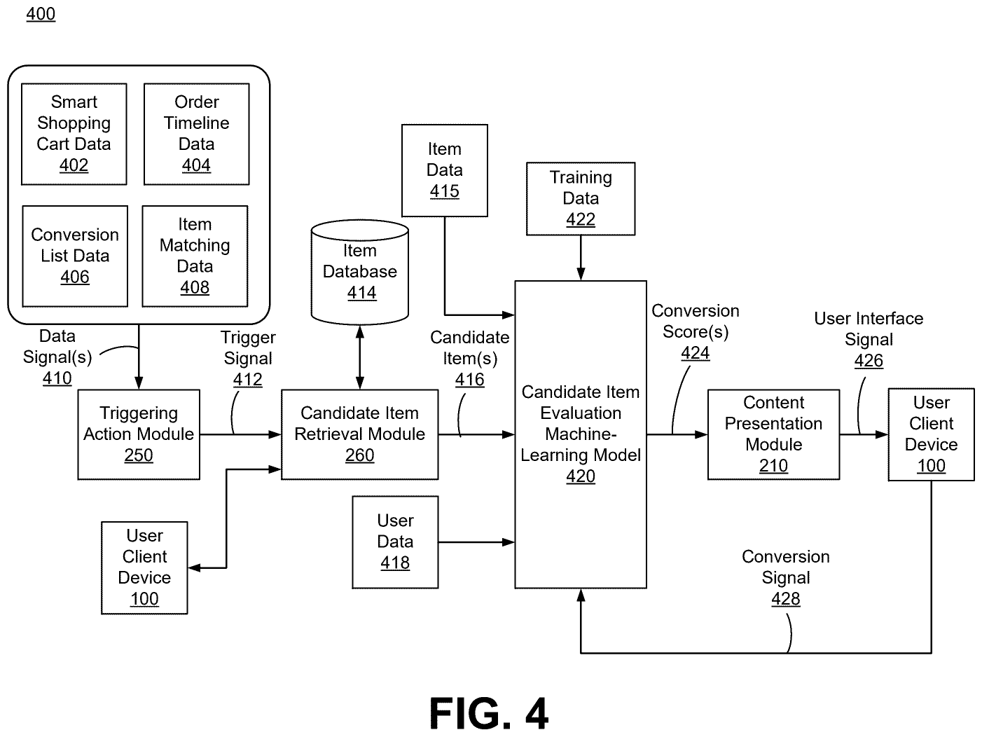

FIG. 4 illustrates an example architectural flow diagram 400 of using a candidate item evaluation machine-learning model 420 to create an online cart for a user of the online system 140 in a source location and a physical cart for a user of the online system 140 who is currently online, in accordance with one or more embodiments. Prior to triggering a flow of creating the online cart/physical cart, one or more data signals 410 may be received and evaluated by the triggering action module 250. In one or more embodiments, the one or more data signals 410 may originate from smart shopping cart data 402, order timeline data, conversion list data 406, and/or item matching data 408. Some additional inputs not shown in FIG. 4 suitable for triggering a flow of creating the online cart/physical cart may be further provided to the triggering action module 250.

The smart shopping cart data 402 may include sensor data (e.g., gathered by one or more sensors of the smart shopping cart 150) with an indication that a user of the online system 140 spent at least a threshold amount of time in a vicinity of one or more specific items (e.g., aisle of larger and/or bulky items) in a location of a source associated with the online system 140. Alternatively or additionally, the smart shopping cart data 402 may include sensor data (e.g., gathered by one or more sensors of the smart shopping cart 150) with an indication that a weight of a physical receptacle of the smart shopping cart 150 includes a set of items added by the user is above a threshold weight. The smart shopping cart data 402 may be communicated from the smart shopping cart 150 to the online system 140 (e.g., the triggering action module 250) via the network 130.

The order timeline data 404 may include an indication about a stage of a current session of the user at a particular conversion channel of the online system 140. In one or more embodiments, the order timeline data 404 may include an indication that a next stage for a session of the user in the source location who uses the smart shopping cart 150 is a checkout stage. In one or more other embodiments, the order timeline data 404 may include an indication that a next stage for an online session of the user is a checkout stage. The order timeline data 404 may be communicated from the smart shopping cart 150 or the user client device 100 to the online system 140 (e.g., the triggering action module 250) via the network 130.

The conversion list data 406 may include a list of items for conversion prepared by the user and stored at the user client device 100. The data signal 410 that is extracted from the conversion list data 406 may include an indication that the user failed to convert (e.g., when shopping in the source location using the smart shopping cart 150) one or more items from the list of items for conversion. Hence, the corresponding data signal 410 may be generated from the conversion list data 406 after the checkout at the source location. The conversion list data 406 may be communicated from the smart shopping cart 150 or the user client device 100 to the online system 140 (e.g., the triggering action module 250) via the network 130.

The item matching data 408 may include information about a set of items that were recently converted by the user and a list of items where each item from the list matches (i.e., complements with) the set of converted items. In one or more embodiments, each item from the list together with the set of converted items forms a specific recipe from a recipe database (e.g., stored at the data store 240). The item matching data 408 may be communicated from the smart shopping cart 150 or the user client device 100 to the online system 140 (e.g., the triggering action module 250) via the network 130.

The triggering action module 250 may generate, based on the one or more data signals 410, a trigger signal 412 that triggers the flow of creating the online cart/physical cart. The triggering action module 250 may pass the trigger signal 412 to the candidate item retrieval module 260. Responsive to the trigger signal 412, the candidate item retrieval module 260 may retrieve one or more candidate items 416 for recommendation to the user to convert via a conversion channel of the online system 140 that is different from a conversion channel currently utilized by the user. In one or more embodiments, the candidate item retrieval module 260 retrieves the one or more candidate items 416 from a database 414 of the online system 140 as one or more items that were previously converted by the user (e.g., buy-it-again items). In one or more other embodiments, the candidate item retrieval module 260 retrieves the one or more candidate items 416 from the database 414 that complement a set of items converted by the user using the current conversion channel (e.g., the one or more candidate items 416 and the set of converted items form a recipe stored in the database 414).

In one or more other embodiments, the candidate item retrieval module 260 retrieves the one or more candidate items 416 from a list of items for conversion stored at the user client device 100, wherein the one or more candidate items 416 were not converted by the user using the current conversion channel. Alternatively or additionally, the trigger signal 412 may include an indication that the user converted a specific item using the current conversion channel. Based on the trigger signal 412, the candidate item retrieval module 260 may retrieve the one or more candidate items 416 from the database 414 that are labeled by a source associated with the online system 140 for recommendation to the user once the specific item is converted. In such cases, the one or more candidate items 416 may be items sponsored by the source for conversion using a particular conversion channel. The candidate item retrieval module 260 may pass the one or more candidate items 416 to a candidate item evaluation machine-learning model 420.

Before deploying a machine-learning algorithm of the candidate item evaluation machine-learning model 420, the online system 140 may perform (e.g., via the machine-learning training module 230) initial training of the candidate item evaluation machine-learning model 420 using training data 422 to generate initial values for the set of parameters of the candidate item evaluation machine-learning model 420. The training data 422 may be generated (e.g., via the machine-learning training module 230) by collecting information, from the database 414, about a set of items each having a conversion rate above a threshold rate for a specific conversion channel of the online system 140. Alternatively or additionally, the training data 422 may be generated (e.g., via the machine-learning training module 230) by collecting information about past item recommendations provided to a collection of users of the online system 140 including information about conversion of recommended items by the collection of users. Alternatively or additionally, the training data 422 may be generated (e.g., via the machine-learning training module 230) by retrieving information from a user order history (e.g., stored at the database 414) if the user missed a key item that the user usually purchases. After the initial training process of the candidate item evaluation machine-learning model 420 is completed, the online system 140 may provide a set of inputs to the candidate item evaluation machine-learning model 420 (e.g., via the candidate item evaluation module 270), such as item data 415 and user data 418. Some additional inputs not shown in FIG. 4 suitable for identifying a likelihood of conversion of each of the one or more candidate items 416 may be further provided to the candidate item evaluation machine-learning model 420.

In providing the set of inputs to the candidate item evaluation machine-learning model 420, the candidate item evaluation module 270 may provide the item data 415 that include information about an availability of each candidate item 416 in a source location, e.g., information on whether each candidate item 416 is out-of-stock in the source location, as well as whether each candidate item 416 is available at some other source location of a same source associated with the online system 140. The item data 415 may be communicated to the candidate item evaluation module 270 from the smart shopping cart 150 and/or the source computing system 120 via the network 130.

In providing the set of inputs to the candidate item evaluation machine-learning model 420, the candidate item evaluation module 270 may further provide user data 418 including information that the user that utilizes the smart shopping cart 150 for shopping in the source location is spending at least a threshold amount of time in an aisle with an abundance of bulky items, information about user's order history including information about what conversion channel of the online system 140 the user utilized for conversion of specific items, some other user-related data, or some combination thereof.

The candidate item evaluation machine-learning model 420 may apply a machine-learning algorithm to the item data 415 and the user data 418 to output one or more conversion scores 424 for the one or more candidate items 416, where each conversion score 424 indicates a likelihood of conversion of a respective candidate item 416 by the user via a conversion channel of the online system 140 that is different from a conversion channel of the online system 140 that is currently employed by the user. The candidate item evaluation machine-learning model 420 may pass the one or more conversion scores 424 that are above a threshold score to the content presentation module 210 along with an identifier of each corresponding candidate item 416. Alternatively, the candidate item evaluation machine-learning model 420 (or the candidate item evaluation module 270) may rank the candidate items 416 based on their conversion scores 424, and the pass only the highest conversion score 424 (if greater than the threshold score) along with an identification of a corresponding candidate item 416 to the content presentation module 210.

The content presentation module 210 may generate, based on the one or more conversion scores 424 and identification(s) of the one or more candidate items, a user interface signal 426 for prompting the user to use a different conversion channel of the online system 140 for conversion of the one or more candidate items 416. The user interface signal 426 may be communicated, via the network 130, to the user client device 100 (or the smart shopping cart 150). Based on the user interface signal 426, a user interface at the user client device 100 (or at the dashboard 315 of the smart shopping cart 150) may be generated that prompts the user to use the different conversion channel for conversion of the one or more candidate items 416. In one or more embodiments, the user interface at the user client device 100 displays a message (e.g., generated by the content presentation module 210) prompting the user to come to a location of a source associated with the online system 140 to pick up the one or more candidate items 416. In one or more other embodiments, the user interface at the dashboard 315 of the smart shopping cart 150 displays a message (e.g., generated by the content presentation module 210) recommending to the user a delivery of the one or more candidate items 416 to a home location of the user, wherein the user is currently in a location of a source associated with the online system 140.

The user client device 100 (or the smart shopping cart 150, or the source computing system 120) may record a conversion signal 428 with information about a conversion of each of the one or more candidate items 416 by the user using the different conversion channel. The online system 140 may receive (e.g., via the machine-learning training module 230) the conversion signal 428 from the user client device 100 (or the smart shopping cart 150, or the source computing system 120) via the network 130. The machine-learning training module 230 may utilize the conversion signal 428 to re-train the candidate item evaluation machine-learning model 420. By utilizing the conversion signal 428, the machine-learning training module 230 may update the set of parameters of the candidate item evaluation machine-learning model 420 and continuously improve the machine-learning algorithm of the candidate item evaluation machine-learning model 420.

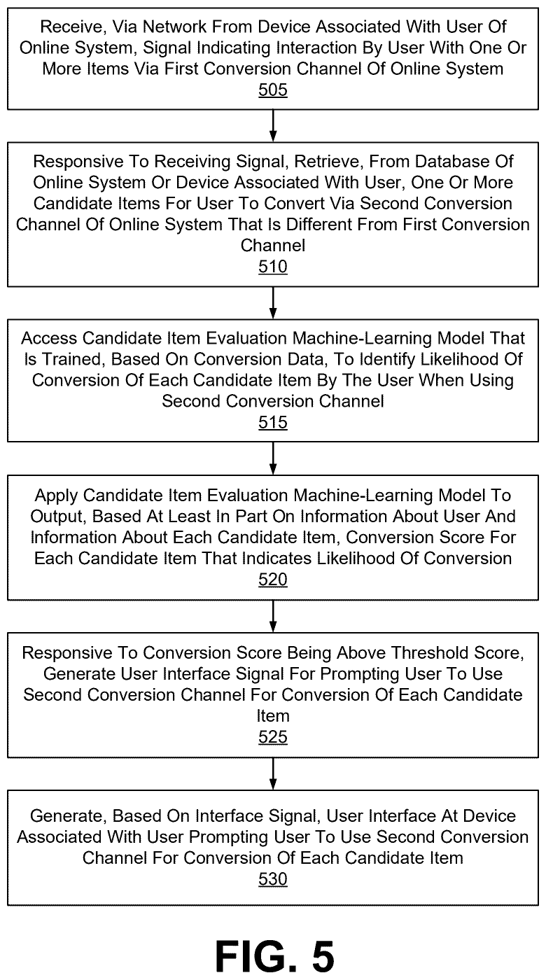

FIG. 5 is a flowchart for a method of using a trained machine-learning model of an online system to create an online cart for a user of the online system in a source location and a physical cart for a user of the online system who is currently online, in accordance with one or more embodiments. Alternative embodiments may include more, fewer, or different steps from those illustrated in FIG. 5, and the steps may be performed in a different order from that illustrated in FIG. 5. These steps may be performed by an online system (e.g., the online system 140). Additionally, each of these steps may be performed automatically by the online system without human intervention.

The online system 140 receives 505 (e.g., at the triggering action module 250), via a network (e.g., the network 130) from a device associated with a user of the online system 140 (e.g., the user client device 100 or the smart shopping cart 150), a signal indicating an interaction by the user with one or more items via a first conversion channel of the online system 140. The first conversion channel may be an online shopping channel. Alternatively, the first conversion channel may be an in-store shopping channel.

The online system 140 may gather, via one or more sensors mounted to the device associated with the user (e.g., the cameras 305 of the smart shopping cart 150), sensor data with an indication that the user is in a vicinity of one or more specific items (e.g., heavy and/or bulky items) in a location of a source associated with the online system 140. The online system 140 may then receive (e.g., at the triggering action module 250), from the device associated with the user and via the network, the signal that includes the indication that the user is in the vicinity of the one or more specific items in the location of the source.

Alternatively or additionally, the online system 140 may gather, via one or more sensors mounted to the device associated with the user (e.g., the weight sensors 310 of the smart shopping cart 150), sensor data with an indication that a weight of a physical receptacle of the device associated with the user that includes a set of items is above a threshold weight. The online system 140 may then receive (e.g., at the triggering action module 250), from the device associated with the user and via the network, the signal comprising the indication that the weight of the physical receptacle is above the threshold weight.

Alternatively or additionally, the online system 140 may receive (e.g., at the triggering action module 250), from the device associated with the user and via the network, the signal that includes an indication that a next stage of a current session of the user at the first conversion channel is a defined stage (e.g., checkout stage). Alternatively, the online system 140 may receive (e.g., at the triggering action module 250), from the device associated with the user and via the network, the signal that includes an indication that the user failed to convert, using the first conversion channel, an item from a list of items stored at the device associated with the user.

Responsive to receiving the signal, the online system 140 retrieves 510 (e.g., via the candidate item retrieval module 260), from a database of the online system 140 (e.g., the data store 240) or the device associated with the user, one or more candidate items for the user to convert via a second conversion channel of the online system 140 that is different from the first conversion channel. Based on the received signal, the triggering action module 250 may generate a triggering signal for the candidate item retrieval module 260 to retrieve the one or more candidate items from the database. The second conversion channel may be an in-store shopping channel. Alternatively, the second conversion channel may be an online shopping channel.

The online system 140 may retrieve (e.g., via the candidate item retrieval module 260) each of the one or more candidate items from a set of items at the database that were previously converted by the user. Alternatively or additionally, the online system 140 may retrieve (e.g., via the candidate item retrieval module 260) each of the one or more candidate items from a list of items stored at the device associated with the user for conversion using the first conversion channel, wherein each of the one or more candidate items was not converted by the user using the first conversion channel. Alternatively or additionally, the online system 140 may retrieve (e.g., via the candidate item retrieval module 260) each of the one or more candidate items that complements a set of items converted by the user using the first conversion channel. For example, each of the one or more candidate items together with the set of items may form a specific recipe that is stored at the database.

In one or more embodiments, the online system 140 receives the signal by receiving (e.g., at the triggering action module 250), from the device associated with the user and via the network, an indication that the user converted an item using the first conversion channel. The online system 140 may then retrieve (e.g., via the candidate item retrieval module 260) each of the one or more candidate items by retrieving, from the database in response to the received indication, each of the one or more candidate items that is labeled by a source associated with the online system 140 once the item is converted.

The online system 140 accesses 515 a candidate item evaluation machine-learning model of the online system 140 (e.g., via the candidate item evaluation module 270), wherein the candidate item evaluation machine-learning model is trained, based on conversion data, to identify a likelihood of conversion of each of the one or more candidate items by the user when using the second conversion channel. The online system 140 applies 520 the candidate item evaluation machine-learning model (e.g., via the candidate item evaluation module 270) to output, based at least in part on information about the user and information about each of the one or more candidate items, a conversion score for each of the one or more candidate items that indicates the likelihood of conversion.

Responsive to the conversion score being above a threshold score, the online system 140 generates 525 (e.g., via the content presentation module 210) a user interface signal for prompting the user to use the second conversion channel for conversion of each of the one or more candidate items. The online system 140 generates 530 (e.g., via the content presentation module 210), based on the interface signal, a user interface at the device associated with the user prompting the user to use the second conversion channel for conversion of each of the one or more candidate items.

In one or more embodiments, the online system 140 generates (e.g., via the content presentation module 210) the user interface that displays a message prompting the user to come to a location of a source associated with the online system 140 to pick up the one or more candidate items. In one or more other embodiments, the online system 140 generates (e.g., via the content presentation module 210) the user interface that displays a message prompting the user to accept a delivery of the one or more candidate items to a location of the user that is stored in the database, wherein the user is currently in a location of a source associated with the online system 140.

The online system 140 may generate (e.g., via the machine-learning training module 230) training data by collecting, from the database, the conversion data including information about a set of items each having a conversion rate above a threshold rate for a conversion channel of the online system 140. The online system 140 may train (e.g., via the machine-learning training module 230), using the training data, the candidate item evaluation machine-learning model to generate a set of initial values for a set of parameters of the candidate item evaluation machine-learning model. The online system 140 may collect (e.g., via the machine-learning training module 230) feedback data with information about a conversion of each of the one or more candidate items by the user using the second conversion channel. The online system 140 may re-train the candidate item evaluation machine-learning model by updating (e.g., via the machine-learning training module 230), using the collected feedback data, the set of parameters of the candidate item evaluation machine-learning model.

Embodiments of the present disclosure are directed to the online system 140 that utilizes a trained machine-learning model to create an online cart for a user of the online system 140 who is in a source location, as well as to create a physical cart for a user of the online system 140 who is currently building an online order. The online system 140 presented herein employs the trained machine-learning model to prompt the user to opt for fulfillment of an order through a different channel, such as, to add an item to an online cart from a source location or to add an item to an in-store cart (e.g., physical cart) from an online interface of the online system 140.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network from a device associated with a user of an online system, a signal indicating an interaction by the user with one or more items via a first conversion channel of the online system;
responsive to receiving the signal, retrieving, from a database of the online system or the device associated with the user, one or more candidate items for the user to convert via a second conversion channel of the online system that is different from the first conversion channel;
accessing a candidate item evaluation machine-learning model of the online system, wherein the candidate item evaluation machine-learning model is trained, based on conversion data, to identify a likelihood of conversion of each of the one or more candidate items by the user when using the second conversion channel;
applying the candidate item evaluation machine-learning model to output, based at least in part on information about the user and information about each of the one or more candidate items, a conversion score for each of the one or more candidate items that indicates the likelihood of conversion;
responsive to the conversion score being above a threshold score, generating a user interface signal for prompting the user to use the second conversion channel for conversion of each of the one or more candidate items; and
generating, based on the interface signal, a user interface at the device associated with the user prompting the user to use the second conversion channel for conversion of each of the one or more candidate items.

2. The method of claim 1, wherein receiving the signal comprises:
gathering, via one or more sensors mounted to the device associated with the user, sensor data with an indication that the user is in a vicinity of one or more specific items in a location of a source associated with the online system; and
receiving, from the device associated with the user and via the network, the signal comprising the indication that the user is in the vicinity of the one or more specific items in the location of the source.

3. The method of claim 1, wherein receiving the signal comprises:
gathering, via one or more sensors mounted to the device associated with the user, sensor data with an indication that a weight of a physical receptacle of the device associated with the user that comprises a set of items is above a threshold weight; and
receiving, from the device associated with the user and via the network, the signal comprising the indication that the weight of the physical receptacle is above the threshold weight.

4. The method of claim 1, wherein receiving the signal comprises:
receiving, from the device associated with the user and via the network, the signal comprising an indication that a next stage of a current session of the user at the first conversion channel is a defined stage.

5. The method of claim 1, wherein receiving the signal comprises:
receiving, from the device associated with the user and via the network, the signal comprising an indication that the user failed to convert, using the first conversion channel, an item from a list of items stored at the device associated with the user.

6. The method of claim 1, wherein retrieving each of the one or more candidate items comprises:
retrieving each of the one or more candidate items from a set of items at the database that were previously converted by the user.

7. The method of claim 1, wherein retrieving each of the one or more candidate items comprises:
retrieving each of the one or more candidate items from a list of items stored at the device associated with the user for conversion using the first conversion channel, wherein each of the one or more candidate items was not converted by the user using the first conversion channel.

8. The method of claim 1, wherein retrieving each of the one or more candidate items comprises:
retrieving, from the database, each of the one or more candidate items that complements a set of items converted by the user using the first conversion channel.

9. The method of claim 1, wherein:
receiving the signal comprises receiving, from the device associated with the user and via the network, an indication that the user converted an item using the first conversion channel; and
retrieving each of the one or more candidate items comprises retrieving, from the database in response to the received indication, each of the one or more candidate items that is labeled by a source associated with the online system once the item is converted.

10. The method of claim 1, wherein generating the user interface comprises:
generating the user interface that displays a message prompting the user to come to a location of a source associated with the online system to pick up the one or more candidate items.

11. The method of claim 1, wherein generating the user interface comprises:
generating the user interface that displays a message prompting the user to accept a delivery of the one or more candidate items to a location of the user that is stored in the database, wherein the user is currently in a location of a source associated with the online system.

12. The method of claim 1, further comprising:
generating training data by collecting, from the database, the conversion data including information about a set of items each having a conversion rate above a threshold rate for a conversion channel of the online system; and
training, using the training data, the candidate item evaluation machine-learning model to generate a set of initial values for a set of parameters of the candidate item evaluation machine-learning model.

13. The method of claim 1, further comprising:
collecting feedback data with information about a conversion of each of the one or more candidate items by the user using the second conversion channel; and
re-training the candidate item evaluation machine-learning model by updating, using the collected feedback data, a set of parameters of the candidate item evaluation machine-learning model.

14. A computer program product comprising a non-transitory computer readable storage medium having instructions encoded thereon that, when executed by a processor, cause the processor to perform steps comprising:
receiving, via a network from a device associated with a user of an online system, a signal indicating an interaction by the user with one or more items via a first conversion channel of the online system;
responsive to receiving the signal, retrieving, from a database of the online system or the device associated with the user, one or more candidate items for the user to convert via a second conversion channel of the online system that is different from the first conversion channel;
accessing a candidate item evaluation machine-learning model of the online system, wherein the candidate item evaluation machine-learning model is trained, based on conversion data, to identify a likelihood of conversion of each of the one or more candidate items by the user when using the second conversion channel;
applying the candidate item evaluation machine-learning model to output, based at least in part on information about the user and information about each of the one or more candidate items, a conversion score for each of the one or more candidate items that indicates the likelihood of conversion;
responsive to the conversion score being above a threshold score, generating a user interface signal for prompting the user to use the second conversion channel for conversion of each of the one or more candidate items; and
generating, based on the interface signal, a user interface at the device associated with the user prompting the user to use the second conversion channel for conversion of each of the one or more candidate items.

15. The computer program product of claim 14, wherein the instructions further cause the processor to perform steps comprising:
gathering, via one or more sensors mounted to the device associated with the user, sensor data with an indication that the user is in a vicinity of one or more specific items in a location of a source associated with the online system; and
receiving, from the device associated with the user and via the network, the signal comprising the indication that the user is in the vicinity of the one or more specific items in the location of the source.

16. The computer program product of claim 14, wherein the instructions further cause the processor to perform steps comprising:
gathering, via one or more sensors mounted to the device associated with the user, sensor data with an indication that a weight of a physical receptacle of the device associated with the user that comprises a set of items is above a threshold weight; and
receiving, from the device associated with the user and via the network, the signal comprising the indication that the weight of the physical receptacle is above the threshold weight.

17. The computer program product of claim 14, wherein the instructions further cause the processor to perform steps comprising:
receiving the signal by receiving, from the device associated with the user and via the network, an indication that the user converted an item using the first conversion channel; and
retrieving each of the one or more candidate items by retrieving, from the database in response to the received indication, each of the one or more candidate items that is labeled by a source associated with the online system once the item is converted.

18. The computer program product of claim 14, wherein the instructions further cause the processor to perform steps comprising:
generating the user interface that displays a first message prompting the user to come to a first location of a first source associated with the online system to pick up the one or more candidate items; or
generating the user interface that displays a second message prompting the user to accept a delivery of the one or more candidate items to a location of the user that is stored in the database, wherein the user is currently in a second location of a second source associated with the online system.

19. The computer program product of claim 14, wherein the instructions further cause the processor to perform steps comprising:
generating training data by collecting, from the database, the conversion data including information about a set of items each having a conversion rate above a threshold rate for a conversion channel of the online system;
training, using the training data, the candidate item evaluation machine-learning model to generate a set of initial values for a set of parameters of the candidate item evaluation machine-learning model;
collecting feedback data with information about a conversion of each of the one or more candidate items by the user using the second conversion channel; and
re-training the candidate item evaluation machine-learning model by updating, using the collected feedback data, the set of parameters of the candidate item evaluation machine-learning model.

20. A computer system comprising:
a processor; and
a non-transitory computer-readable storage medium having instructions that, when executed by the processor, cause the computer system to perform steps comprising:
receiving, via a network from a device associated with a user of an online system, a signal indicating an interaction by the user with one or more items via a first conversion channel of the online system;
responsive to receiving the signal, retrieving, from a database of the online system or the device associated with the user, one or more candidate items for the user to convert via a second conversion channel of the online system that is different from the first conversion channel;
accessing a candidate item evaluation machine-learning model of the online system, wherein the candidate item evaluation machine-learning model is trained, based on conversion data, to identify a likelihood of conversion of each of the one or more candidate items by the user when using the second conversion channel;
applying the candidate item evaluation machine-learning model to output, based at least in part on information about the user and information about each of the one or more candidate items, a conversion score for each of the one or more candidate items that indicates the likelihood of conversion;
responsive to the conversion score being above a threshold score, generating a user interface signal for prompting the user to use the second conversion channel for conversion of each of the one or more candidate items; and
generating, based on the interface signal, a user interface at the device associated with the user prompting the user to use the second conversion channel for conversion of each of the one or more candidate items.
